(19) United States
(12) Patent Application Publication
(10) Pub. No.: US 2018/0153107 A1
(43) Pub. Date: Jun. 7, 2018

(54) PLANT CONTAINER

(71) Applicant: Local Tree Care Pty Ltd, Wodonga, Victoria (AU)

(72) Inventors: Sandra Leanne Kramer, Wodonga (AU); Colin Patrick Kramer, Wodonga (AU)

(21) Appl. No.: 15/737,656

(22) PCT Filed: Jun. 30, 2016
(86) PCT No.: PCT/AU2016/050569

§ 371 Date: Dec. 18, 2017

(30) Foreign Application Priority Data
Jul. 1, 2015 (AU) 2015902582

(51) Int. Cl. A01G 9/02; A47G 7/04; D04B 1/22; D03D 1/00; D04B 21/12; D04B 21/20; D03D 9/00

(52) U.S. Cl. CPC A01G 9/026; A47G 7/041; D04B 1/22; A01G 2009/003; D04B 21/12; D04B 21/20; D03D 9/00; D03D 1/00

(57) ABSTRACT

A plant container with one or more sides including a mesh for air pruning

### BACKGROUND

Plants are often raised in containers in plant nurseries. The plants are often trees for use in parks and along streets and for private household use. The containers are often enclosed, e.g., hard-walled plastic pots, with holes in the base of the pots to allow water drainage.

These containers can be damaged when removing the plants for installation, and are then discarded.

Enclosed plant containers cause root problems. For example, roots in an enclosed container can grow around the container in a constricted pattern, causing the roots to circle around the container, or bend back into the container away from the container's edge. When such a plant is installed from the container, it can fail to establish a normal root structure, causing problems with stability, intake of water and nutrients, etc.

Constricted root growth in a plant container can be reduced through the use of “air-pruning” containers. Example air-pruning containers include hard-walled containers with holes in the sides, and containers formed of geofabric (i.e., a solid geosynthetic material). The side walls of the hard plastic air-pruning containers include open-ended depressions (i.e., curved funnels, referred to as “cusps”) that guide roots to the side holes while still retaining the growing media (i.e., natural or artificial soil): when the roots reach the side walls, the ends of the roots are guided to the side holes, and are thus exposed to the air and light surrounding the container: exposure to air and light in this fashion causes the ends of the roots to be pruned in a process referred to as “air pruning”. For the geofabric containers, the roots are air pruned when they extend through the geofabric. The air pruning can reduce girdling and circling root issues, and can encourage a more fibrous root ball inside the container. This allows for healthy root-structure growth when the plant is installed in a larger container or in the ground. Increasingly, customers/clients are requiring plants to be raised in air-pruning containers to ensure better plant health after installation, e.g., local and municipal councils installing trees in streets or parks.

However, existing containers used for air pruning are more difficult to manufacture and/or use than hard plastic pots. For example: careful shaping of the side walls of the hard-walled containers is required to retain the growing media while directing roots to the side holes. Furthermore, grown plants cannot be pulled out vertically because the roots and media are engaged in the shaped side walls (or hard plastic air-pruning containers) or the geofabric walls. For hard plastic air-pruning containers, the side walls are often removed laterally, e.g., in two or more parts that can be difficult to operate and keep together for subsequent usage (e.g., parts can get lost when planting many trees).

The hard-walled air-pruning containers are designed for using more than once (“re-use”), and typically when a plant is sold in one of these containers it is removed from the container at the nursery and placed into a plastic bag to be sold to the client. This is because inexperienced clients can find it difficult to operate these containers, and to keep all of the parts together and undamaged for return to the nursery. During transport, root disturbance can occur when the plants have been bagged. The hard plastic air-pruning containers can be difficult to operate by inexperienced people, e.g., workers installing trees, so the hard plastic air-pruning containers are often removed at a nursery and bagged into plastic bags that cannot be reused and generally end up in landfill. The hard plastic air-pruning containers consist of various components that have to be assembled for use, and typically have a base, one or two wall sections and one or two shafts to hold the walls and base together.

The hard plastic air-pruning containers are difficult to carry.

Existing air-pruning containers may provide improved air and light exposure along the sides of the plants, but may have insufficient air flow and light for air pruning underneath the plants, i.e., under the container base, resulting in large sections of root matter having to be cut out of the container prior to installation or bagging.

With existing air-pruning containers, monitoring root development or efficiency of irrigation can be difficult: e.g., for a hard plastic air-pruning container, a person has to physically remove the walls to observe the outer region of the growing media, and problems may be encountered reassembling the containers after the inspection.

For re-use, the hard plastic air-pruning containers have to be washed, and all root matter removed from the base, prior to their next use.

Irrigation of the hard plastic air-pruning containers can result in water flowing out of the cusps at the upper region of the container and not penetrating the root ball efficiently. Irrigation of the geofabric containers can result in water dripping or flowing out of the geofabric sides, e.g., approximately ⅓ to ½-way down the sides from the top of the container.

The hard plastic air-pruning containers can be quite bulky when storing prior to re-use, particularly when assembled, and cannot be left in an area where they would be vulnerable to the wind as they can be blown around and damaged. The transportation of these containers after use is complicated by the bulky nature of the containers, which can result in increased transportation costs.

The geofabric containers trap the root matter into the walls and floor of the container that they are grown in, and are not designed to be re-used, thus adding to landfill and requiring replacement containers. The larger geofabric containers are designed to be planted into, and the plants can remain in them for approximately 5 years before being transplanted, after which the geofabric tends to no longer be useable. In use, to transplant the plant, the geofabric bag is thus typically cut down the sides and discarded.

There is a need for plant containers that provide high-quality air pruning but are relatively easy to manufacture, use and re-use.

It is desired to address or ameliorate one or more limitations or disadvantages of the prior art, e.g., including those outlined above; or to at least provide one or more useful alternatives.

### SUMMARY

In accordance with the present invention, there is provided a plant container with one or more sides including a mesh for air pruning.

The mesh can include plastic strands. The mesh can include a mesh fabric with a knitted mesh and/or a woven mesh. The mesh fabric can be a shade cloth.

The mesh can include holes that form two-dimensional shapes. The holes can have widths between 10 millimetres (mm) and 1 mm, or between 6 mm and 3 mm, in particular 3 mm.

The mesh can include a ultra-violet (UV) light-resistant material. The mesh can have a UV resistance between 30% and 90%.

The plant container can include a base including the mesh.

The plant container can include one or more handles on the sides. The handles can be adjacent to the top of the container. The handles can be fabric handles. The handles can be configured to rest directly against the sides in a closed condition. The handles and the sides can be configured to be pulled manually, mutually apart into an open condition. (The handles can be closed by resting directly against the sides, and can be pulled manually away from the sides to open the handles for use.)

The sides can include at least one closure extending from a top of the container. The closure can include a plurality of closures, including two closures in opposite sides of the container. At least one closure can extend from the top to a base of the container. The closure can include cooperating fasteners on its adjacent side panels forming the sides. The fasteners can include cooperating strips of hook and loop fasteners, e.g., the Velcro™ brand.

The one or more sides can form a continuous (circular) wall around the container. (A base of the plant container can be circular). The one or more sides and the base can form a bag substantially formed of the mesh.

The one or more sides can be attached to the base of the container by stitches.

The present invention also provides a method of manufacturing a plant container, including a step of forming sides or a base of the plant container using a mesh for air pruning.

The method can include a step of forming the sides and the base of the container using the mesh, hemming the base, and sewing the sides to the base using stitches.

The method can include attaching one or more handles to the sides by aligning a fabric strip forming the handle along the side, directly adjacent the side, and at a top of the side, so that the handle aligns with the top of the side when not pulled away from the side.

The method can include a step of forming at least one closure in the one or more sides by terminating adjacent side panels forming the sides with cooperating fasteners. The fasteners can include cooperating strips of hook and loop material.

The method can include hemming the edges of the sides.

The present invention also provides a kit including:

the plant container above; and

a stand configured to hold the plant container off the ground, and to allow air circulation for air pruning underneath the base of the plant container.

The stand can include bars or a grid for supporting the plant container, and legs to support the bars or the grid away from the ground.

The container can include a plant with roots extending to the mesh, wherein the roots are pruned by exposure to air and/or light at the mesh.

A method can include steps of:

growing a plant in a plant container; and

air pruning roots of the plant that reach a mesh in sides and/or base of the container.

### BRIEF DESCRIPTION OF THE FIGURES

Preferred embodiments of the present invention are hereinafter described, by way of example only, with reference to the accompanying drawings, in which:

FIG. 1 is a front perspective view of a plant container in a closed condition;

FIG. 2 is a side perspective view of the plant container in the closed condition;

FIG. 3 is a top view of the plant container in the closed condition;

FIG. 4 is a front view of the plant container in the closed condition;

FIG. 5 is a side view of the plant container in the closed condition;

FIG. 6 is a bottom view of the plant container in the closed condition;

FIG. 7 is a front perspective view of the plant container in an open condition;

FIG. 8 is a side perspective view of the plant container in the open condition;

FIG. 9 is a top view of the plant container in the open condition;

FIG. 10 is a detailed view of mesh of the plant container;

FIG. 11 is a top view of a handle of the plant container;

FIG. 12 is a perspective view of the plant container in the closed condition with growing media;

FIG. 13 is a perspective view of a stand for the plant container;

FIG. 14 is a front perspective view of the plant container on the stand;

FIG. 15 is a top view of the plant container in the closed condition on the stand;

FIG. 16 is a schematic diagram of a base of an embodiment of the plant container;

FIG. 17 is a schematic diagram of a side panel of the container;

FIG. 18 is a schematic diagram of a side panel including a handle and a closure;

FIG. 19 is an exploded diagram of components of the plant container;

FIG. 20 is a side perspective view of a top portion of the plant container; and

FIG. 21 is a side view of an embodiment of the plant container with a tree and an embodiment that is empty.

### DETAILED DESCRIPTION

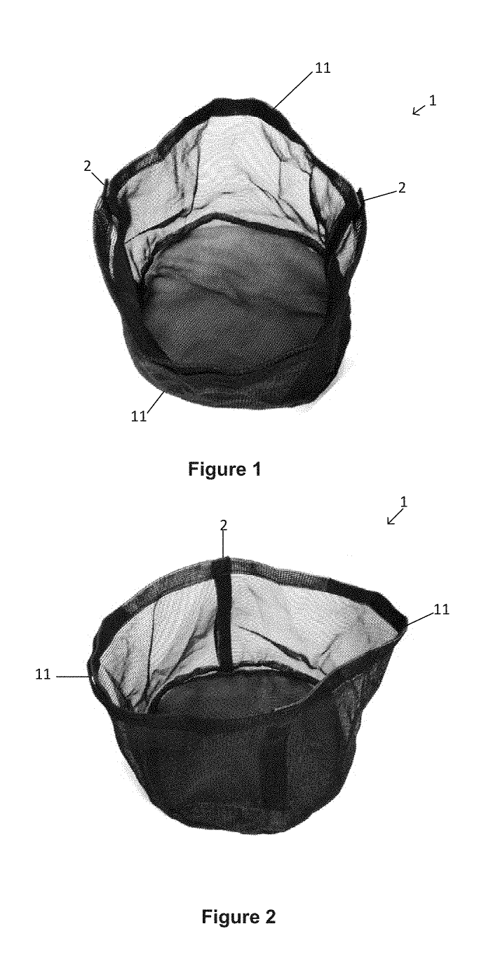

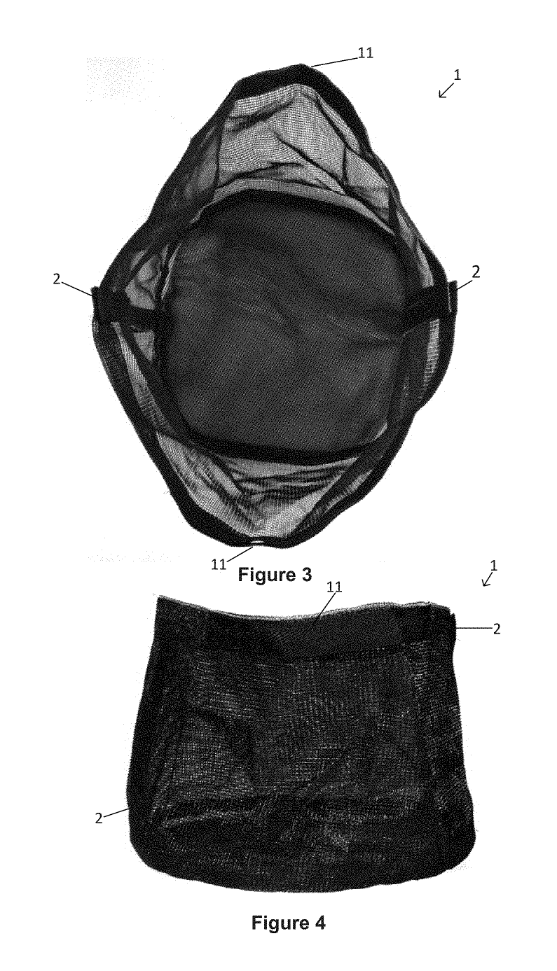

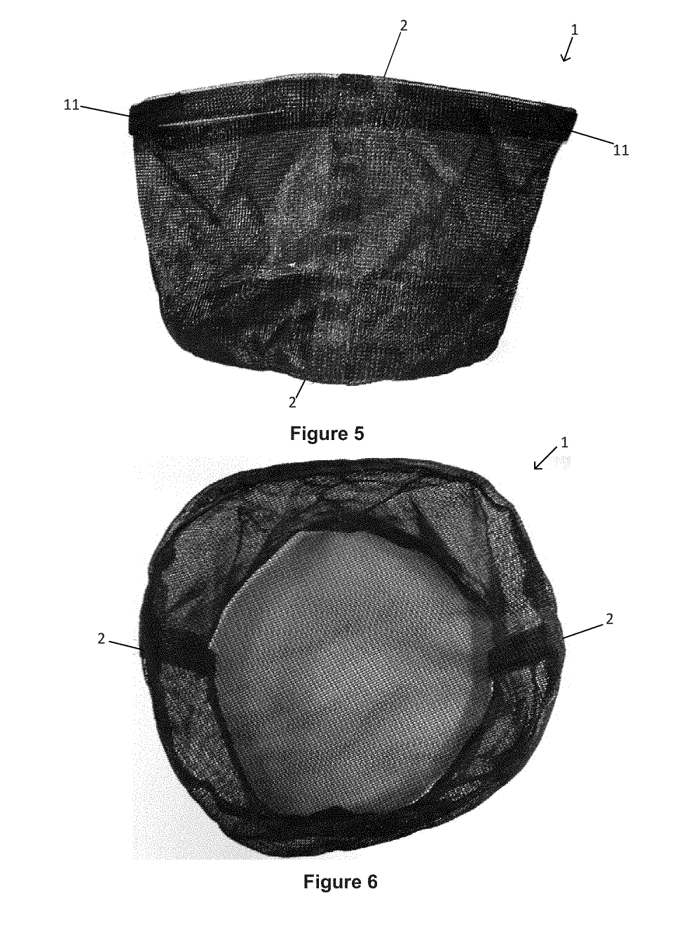

As shown in FIGS. 1 to 6, a plant container 1 has one or more sides that surround an interior of the container 1 when in a closed condition, with a base (also referred to as a “bottom”) joined to the sides to form the open-topped container 1. The one or more sides include a mesh for air pruning roots when a plant is growing inside the plant container 1. The sides and the base are connected to form a one-piece, re-useable air-pruning container 1. The term “mesh” refers to material having an interlaced structure or network of wires or threads or strands, and is also referred to as netting, or a net. The mesh includes holes between the strands that allow passage of air and light such that the mesh is at least partially transparent and allows air flow. The holes are different shapes depending on the construction of the mesh. The mesh is flexible, so the container 1 may be referred to as a “bag”. In embodiments, in a closed condition, as shown in FIGS. 1 to 6, the sides form a continuous generally circular wall around the container 1, and the base of the container 1 is generally circular. As the container 1 is a one-piece product, there are fewer concerns with assembling, disassembling, storing and losing component than with the hard-plastic air-pruning containers. The container 1 is an air-pruning container that can replicate root development in the natural landscape so that when the plants are transplanted, the formative roots are able to access the essential nutrients for their growth and survival from the landscape. This can reduce transplant stress. Once the plants are fully grown and ready for sale, they can be shipped out in the container 1, thus reducing root disturbance during transport and transplant stress. There is no requirement for the plant to be removed from the container 1 and bagged up into a plastic bag to be forwarded to the client for planting. When planting the plant, the process includes simply manually opening closures 2 on the side walls, and removing the plant. After plant removal, the container 1, now empty, can be compressed, folded and bundled together with other containers, and returned to the nursery for sterilisation and re-use. When empty, the container 1 is compact, and the cost burden associated with returning the container 1 is minimal when compared to the hard walled plastic containers that generally end up in landfill. The container 1 is formed of a light-weight mesh, so can be carried by a person easily when empty, and can be stored in a compact condition by folding and stacking prior to re-use.

The spacings and sizes of the holes (also referred to as “air vents”) in the mesh are selected such that, as the roots reach the air vents, they are pruned naturally with the air and light. When the plants are removed from the container 1 there are few if any roots becoming trapped within the air vents, making it easier for them to be cleaned ready for their next use. The mesh has sufficient porosity to be cleaned by water for re-use with a new plant after an old plant has been removed, including cleaning off undesirable growing media, roots, and/or fungal spores for bio-security reasons. The container 1 can be cleaned and sterilised to reduce the threat of soil-borne diseases affecting new plants being planted into the container 1. The mesh extends around a circumference and up a height of the sides, and across the base.

The mesh includes strands (also referred to as “threads” or “filaments” or “yarns”) that form the mesh. The strands are formed of plastic or polymer materials. The strands (also referred to as “threads” or “filaments” or “yarns”) are formed by extrusion of the polymer materials. The polymer materials are synthetic polymers, in particular polyolefin, in particular thermoplastic polymers, in particular polyethylene or polyethene (also known as “polythene”), in particular high-density polyethylene (HDPE), or polyester, or a combination thereof. The strands have a coating of smooth UV-resistant polymers to provide a high resistance to abrasion, and an increased life span when exposed to varying weather extremes. The mesh may be referred to as a “monofilament” mesh if the strands are formed of only one type of material.

As shown in FIG. 10, the mesh is provided by a mesh fabric 10 that can be a knitted mesh or a woven mesh. The term “fabric” refers to material or cloth produced by weaving or knitting fibres or strands. A mesh fabric 10 can be a shade cloth (which can be referred to as “shade cloth fabric”, “shade fabric” or “shade sail cloth”). The mesh fabric 10 can include knitted HDPE outdoor fabrics, and coated HDPE fabrics, e.g., from commercial shade cloth suppliers. The mesh fabric 10 can have a nominal shade percentage ranging from 27% or 28% to 80%, including 27-30%, 28-32%, 51-56%, 67-72%, 76-80%, about 30%, about 50%, about 70% and about 80%. The mesh fabric 10 can weigh between 50 gsm and 400 gsm (Grams per Square Metre), including about 90, about 200, about 240 and about 300 gsm. The mesh fabric 10 can have a breaking force warp of between 350 N/50 mm and 1,000 N/50 mm, including about 380, 740, 800, and 880 N/50 mm. The mesh fabric 10 can have a breaking force weft of between 200 N/50 mm and 1,500 N/50 mm, including about 280, 530, 970, 1140 N/50 mm. The mesh fabric 10 can have a bursting force between 500 and 4,000 kPa (kilopascals), including about 910, 2,100, 2,630, and 3,200 kPa. The mesh fabric 10's ball burst force can range from 500 to 3,000 N, including about 700 N, 1400 N, 1500 N and 2000 N. The mesh fabric 10 can have an elongation warp from 55% to 70%, including about 55%, 50%, 63%, and 60%. The mesh fabric 10 can have an elongation weft from 55% to 90%, including about 85%, 65%, 80%, and 85%. The mesh fabric 10 can have a tear strength warp from 50 to 200 N, including about 80 N, 120 N, 140 N and 165 N. The mesh fabric 10 can have a tear strength warp from 50 to 200 N, including about 80 N, 120 N, 140 N and 165 N. The mesh fabric 10 can have a tear strength weft from 50 to 200 N, including about 60 N, 100 N, 140 N and 185 N.

The mesh can include a UV-resistant material, e.g., a coating on the strands. The mesh can have a UV resistance between 30% and 90% or up to 100%.

The mesh can include holes with widths between about 10 mm and 1 mm, or 6 mm and 1 mm, in particular 3 mm. The holes can form two-dimensional shapes in the plane of the mesh, including repeating shapes across the mesh, including polygons, regular polygons, triangles, quadrilaterals, rectangles, pentagons, hexagons, octagons, circles, ellipses, and combinations of these. These shapes need not be geometrically precise, and can change as the mesh is stretched and folded during use (e.g., by insertion of the growing media, or when folded for storage). The hole width is the distance between opposite sides of the hole along a line through the centre of the hole. The holes in the mesh fabric 10 shown in FIG. 10 have generally square apertures of about 3 mm by 3 mm. The base of the container 1 is also formed of the mesh fabric 10. As shown in FIG. 10, the mesh fabric 10 is a knitted fabric with air vents approximately 3 mm×3 mm extending over the entire length and width of the mesh fabric 10.

The size and volume of the container 1 is defined by a base area (i.e., the two-dimensional area of the base) and a side height. For growing trees to be planted out or installed in the ground (“advanced trees”), the container volume is selected to be about 30 L to 100 L, including 30 L, 45 L and 100 L. For juvenile stock, the container volume is selected to be about 500 mL to 8 L, including 500 mL, 1 L, 1.5 L and 8 L. The base area and height are selected based on the volume. Small containers for the juvenile stock are taller than wide, in ratios of about 1:1.1 to 1:4 (width:height), including 1:1.5, 1:2, 1:2.5, or 1:3. Large containers for the advanced trees are wider than tall, in ratios of about 1.1:1 to 2:1 (width:height), including 1.5:1.

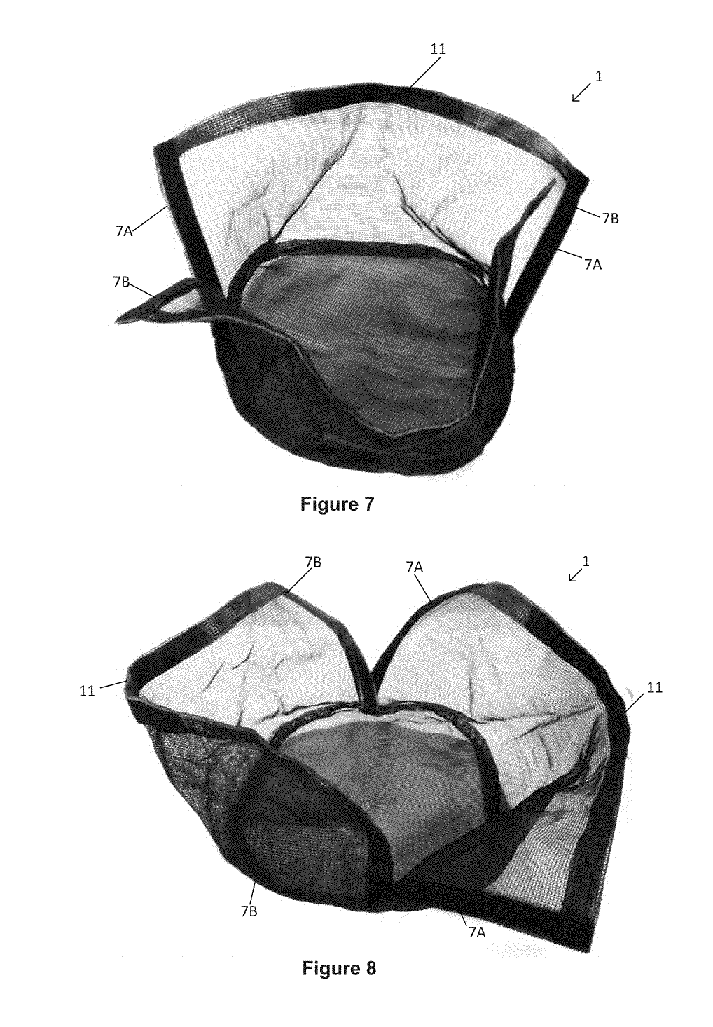

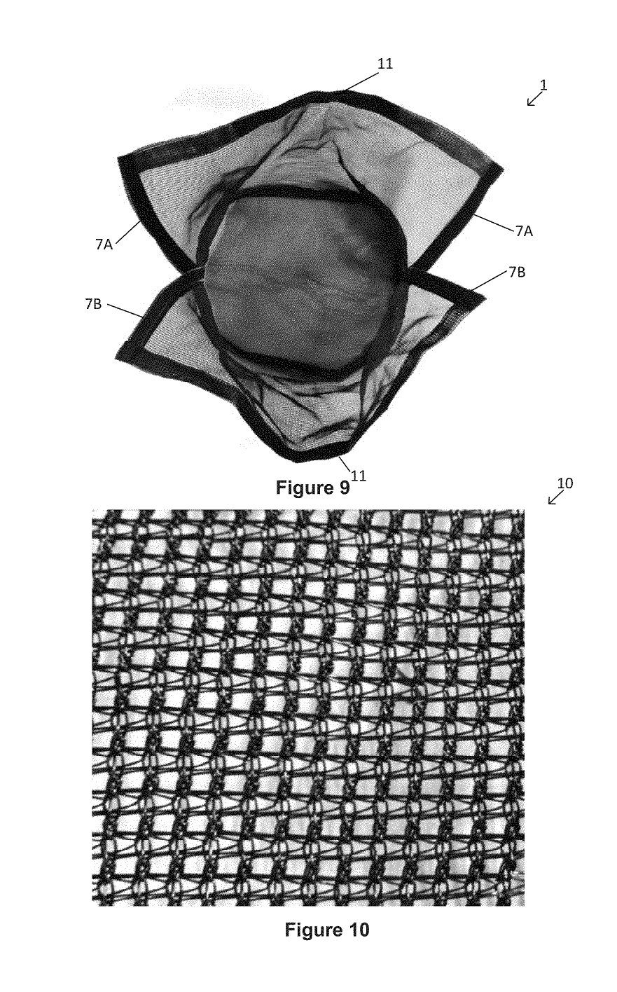

The container 1 includes at least one closure extending from the top of the container 1. The closure is manually openable, and may thus be referred to as a “manually-closable opening”. The closure is reversibly openable, and can thus be opened and closed many times during use of the container 1. As shown in FIGS. 1 to 9, the container 1 includes two closures 2 on opposite sides of the container. Each closure 2 extends from the top to the base of the container 1. Each closure is formed of co-operating fasteners 7A, 7B on its adjacent side panels forming the sides, as shown in FIGS. 7 to 9. The co-operating fasteners 7A, 7B include co-operating strips of hook and loop fasteners, which can be strips of hook-and-loop fastening tape, from TouchTape Inc. or Velcro Inc., which can be 10-mm to 40-mm wide, including 25-mm wide, and be long enough to extend from the top to the base of the container. In embodiments, one side panel of the mesh can be a curved rectangle with each end having one of the co-operating fasteners 7A, 7B on each end. In particular, one side panel can have co-operating fasteners of one type 7A on its ends, while the other side panel has co-operating fasteners of the other type 7B on its ends. The types of the co-operating fasteners can be hooks or loops. The closures 2 allow the side panels or side walls of the sides to be manually opened and closed with ease to assess the irrigation and root development within the container 1.

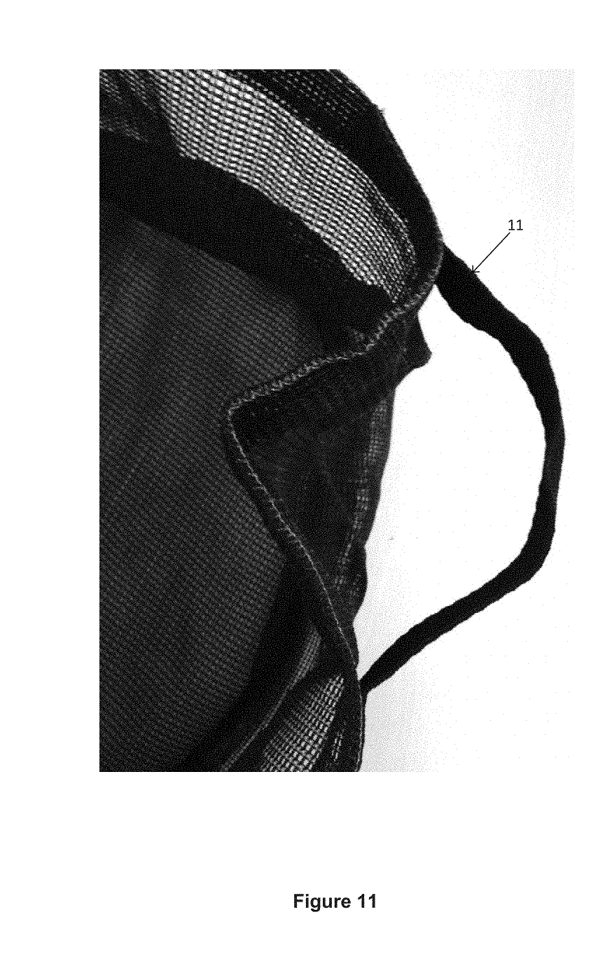

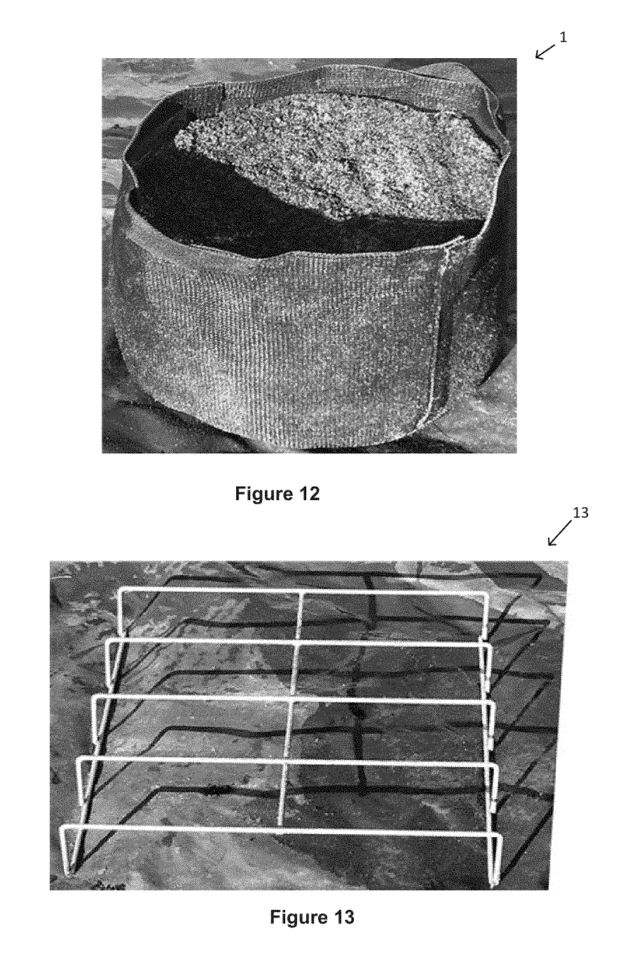

The container 1 includes one or more handles 11 on its sides. Each handle 11 is adjacent a top of the container 1, as shown in FIGS. 1 to 9. Each handle 11 is a fabric handle that is closed by resting directly against the side at the top of the outer side of the container 1, and is opened by pulling the handle 11 manually away from the side, as shown in FIG. 11. The container 1 can have one handle for smaller containers (e.g., 1 to 8 litres (L) in size) and two handles for larger containers (e.g., 30 to 45 L) and four handles for very large containers (e.g., 100 L or larger in size), to assist with transporting. The handles 11 can be made from 25-mm wide polypropylene tape, selected to resist weather extremes. Alternatively, the tape for the handles 11 can be from 10 mm to 100 mm wide, selected based on the size and volume of the embodiment of the container 1.

The design of the container 1 allows for the air pruning of roots that extend to the sides (also referred to as the “outer edge” of the container 1) and to the base of the container 1, thus reducing or eliminating development of circling roots in the container 1, and reducing the risk of girdling and spiralling root problems within the root ball. The design of the container 1 can assist in increased development of fibrous roots within the growing media, can promote root branching throughout the root ball, can increase the capture of irrigation through the exposed soil at the top of the container and through the air vents on all sides of the container, can reduce transplanting issues relating to root disturbance during transport (because the one-piece container 1 is easy to use when installing plants), can assist with health and safety due to handles 11, can assist with ease of installation due to openable side panels. For plants grown in the container 1, on removal of the unsupported rootball from the container 1, at least 90% of the growing media volume can remain intact in or around the rootball, the roots can generally be growing in an outwards (i.e., radial) and downwards direction from the point of initiation, circling roots can generally be absent from the rootball, woody circling roots can generally be absent at the extremity of the rootball, and girdled roots, kinked roots or j-roots can generally be absent.

The irrigation options available with the container 1 include using a flood-and-drain system or overhead irrigation. When irrigating from the surface of the container 1, any water that does not immediately penetrate the soil surface flows to the edge of the container 1, and this overflow water can run down the side walls and back into the container 1, e.g., so that excess water drips out at the base.

Furthermore, the mesh of the side panels allows water to pass through the side walls into the growing media, e.g., when incidental on the side walls due to partially horizontal rain or watering, due to the size of the mesh holes allowing direct contact between the growing media and the incident water. Accordingly, the plants in the container 1 can receive rain and water from many angles, in contrast to existing pots with sides that carry incident water downwards rather than into the growing media.

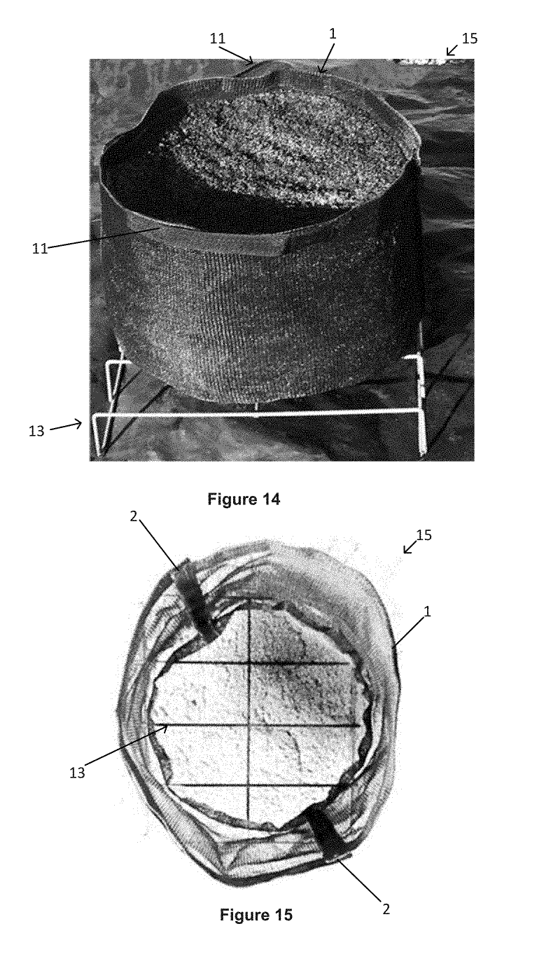

As shown in FIG. 14, the container 1 is designed and sized to sit or rest on a raised rack 13 (also referred to as a “stand”), and the base of the container 1 is formed of the mesh, to air prune roots at the base of the container 1. The container 1 and stand 13 together form a kit 15, as shown in FIGS. 14 and 15. The rack 13, as shown in FIG. 13, includes a plurality of bars or a grid (that form a “rack mesh”) for supporting the container 1 in its filled condition, holding a significant quantity of growing media, as shown in FIG. 14.

For a 45-L container, as shown in FIGS. 13 to 15, the rack 13 can include three parallel bars supporting the container 1 and one transverse centrally located bar supporting the container 1. The parallel bars can be equally spaced, with one bar located centrally beneath the container 1 as shown in FIG. 15, and each of the two other bars being generally in the middle between the central bar and the edge of the base of the container 1 most distant from the centre, as shown in FIG. 15. This configuration of bars provides sufficient support for the filled container 1 to retain its general shape, and to keep the base away from the ground. The rack 13 can include legs attached to the bars, e.g., at the ends of the bars, as shown in FIG. 13, with each bar having a leg at each end. The legs can be formed continuously with the bars by bending the bar at right angles to form the legs. Each leg has one end connected to the bar, and an opposite end forming a foot. The feet of the rack on each side are connected by a foot bar that keeps the bars aligned with each other and with respect to the ground, and resists the feet sinking into the ground, as shown in FIG. 13. The central transverse bar is similarly connected to the bars to maintain the rigid shape of the stand. As shown in FIG. 13, the stand 13 also includes end bars that are parallel to the supporting bars, but that do not necessarily support the filled container 1: these end bars include legs and feet similar to the other bars, and are connected to the other bars, and provide stability to the rack, and can accommodate larger sizes of the container 1. The parallel bars can be mutually spaced by about 100 mm, and a rack with five parallel bars, including two end bars and three supporting bars parallel to each other, can be 400 mm in length. Each of the parallel bars can be about 400 mm in length, thus forming a generally square rack when viewed from above. In embodiments, each of the parallel bars can be 370 mm in length, and the length of the rack transverse to the parallel bars can be 403 mm, which can be using with an embodiment of the container 1 having a diameter of 380 mm. The bars of the rack 13 are formed of galvanised steel wire having a 5 mm thickness. Each leg can be 70 mm long, thus lifting the container 1 about 70 mm from the ground when in use.

For containers 1 of different sizes, the rack 13 differs correspondingly in size. An 8 L container has a rack of approximately 100 mm×100 mm following a “one pot, one rack” system, and a 1 L container has a rack of approximately 50 mm×50 mm in size.

Alternatively or additionally, the rack 13 can support a plurality of containers 1. A plurality of small containers for juvenile stock can share a single rack 13.

In embodiments, the rack 13 can have the following variations. The rack frame can be made from any suitably rigid material, e.g., plastic, steel, rubber, etc. The rack shape, viewed from above, can be any suitable shape to support the container 1 with a plant and soil therein, including a generally square shape, a generally rectangular shape, a generally circular shape, or a generally triangular shape, so long as the rack 13 adequately supports the container 1. The height of the rack 13 can be between 50 mm and 90 mm, or between 60 mm and 80 mm, including about 70 mm, or higher than about 60 mm. The minimum height is to provide sufficient air circulation and water drainage from the bottom of the container 1. The angles of the legs relative to the top face of the rack 13 can vary from about 90 degrees (as shown in FIGS. 13 and 14), so long as the rack 13 reaches the selected height, thus the legs may be at around 45 degrees to the top face of the rack 13, or between 45 and 90 degrees. The rack 13 allows the container 1 to sit with the rack 13 while providing sufficient air flow around the container 1 to enable effective air pruning around the base. The rack mesh can include apertures of different sizes and shapes, formed by the support bars on the top face of the rack 13, so long as there is air flow enabling the air pruning to work effectively on the base of the container 1. The support bars are arranged so the rack mesh has sufficient strength to support the container 1 containing the plant, soil and water. The size of the rack 13 is selected based on the size of the container 1.

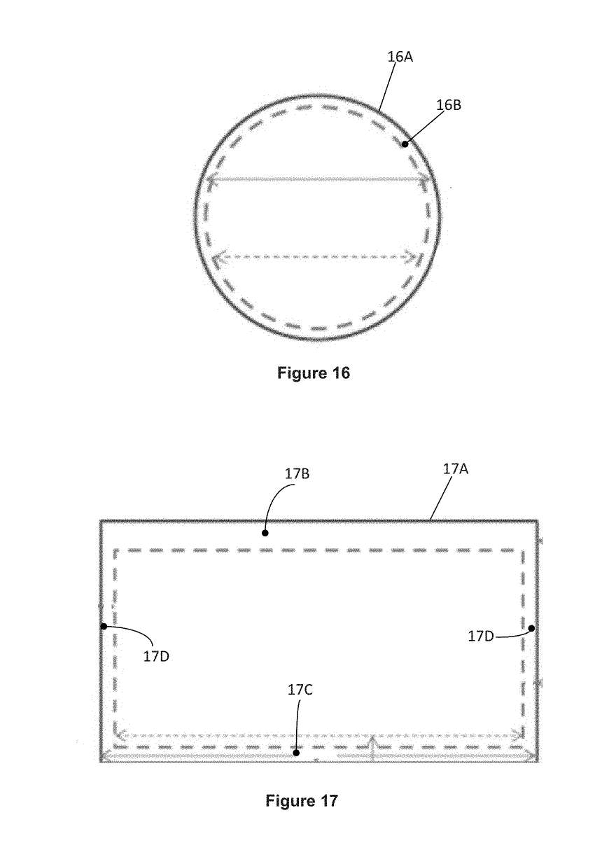

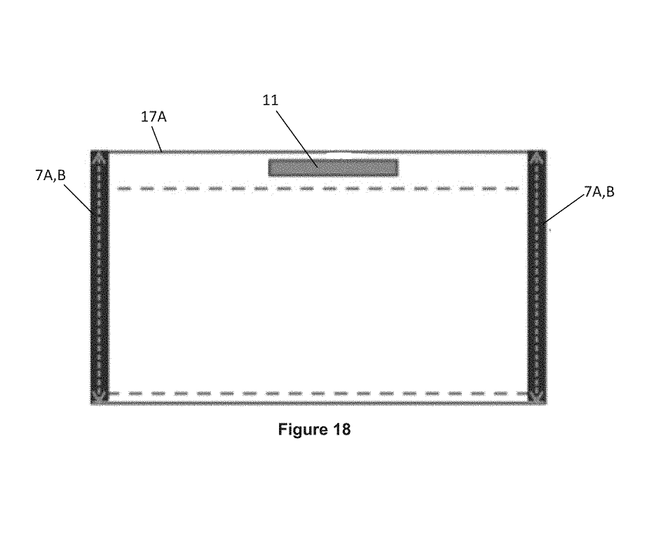

In embodiments, as shown in FIG. 16, the base of the container is formed from a base panel 16A that is sewn to have a base hem 16B. The base panel 16A and the base hem 16B are both generally circular. (For a 45-L bag embodying the container 1, the base panel 16A can have a diameter of 448 mm, and the inner hem 16b can have a diameter of 385 mm.) As shown in FIG. 17, each side panel forming the sides includes a side panel 17A, with a top hem 17B, a bottom hem 17C, and two side hems 17D. (For the 45-L bag, the side panel 17A can have a width of 678 mm, a top hem 17B of 50 mm, a bottom hem 17C of 20 mm, and side hems 17D of 20 mm each, and the un-hemmed distance between the side hems for the 45-L bag is 638 mm.) As shown in FIG. 18, the handle 11 is sewn centrally in the top hem 17B, and the co-operating fasteners 7A, 7B are sewn into the side hem 17D, extending from the base to the top of each side panel 17A at each end of the side panel 17A. (For the 45-L bag, the handle fabric is 245 mm in length, and each fastener 7A, 7B is 260 mm in length, reaching from the top to the bottom of the side panel 17A: for the 45-L bag, the overall bag diameter is about 380 mm, and each handle is about 245 mm in length, including the attached ends thereof).

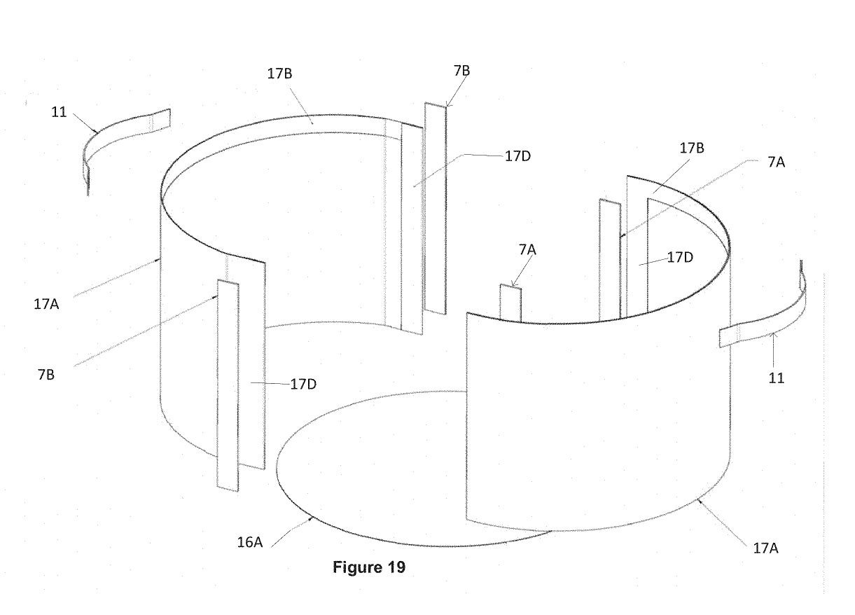

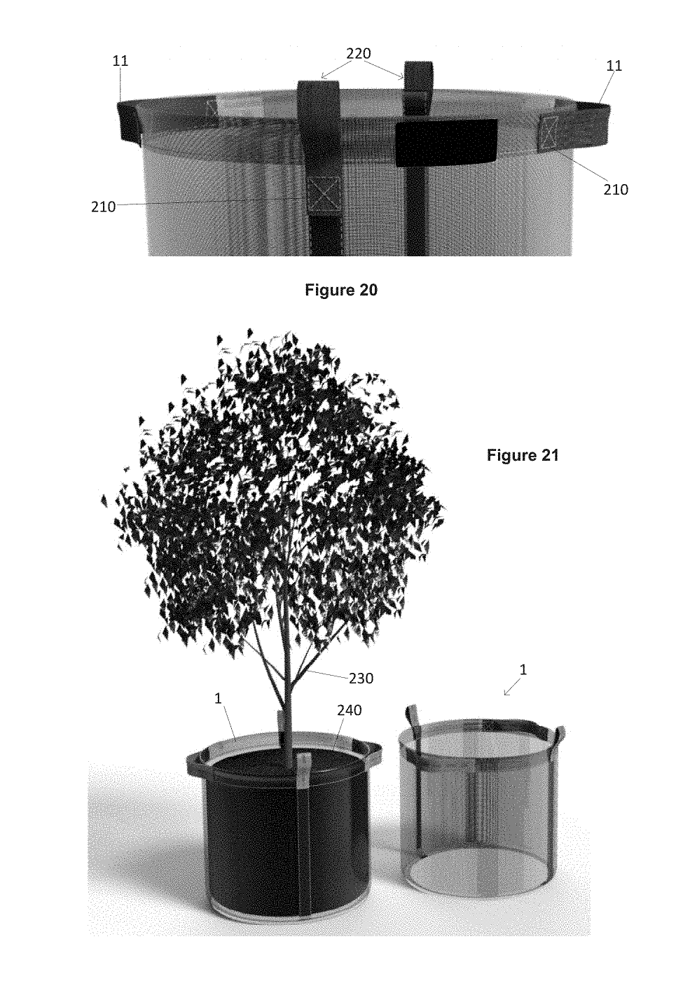

In embodiments, as shown in FIGS. 19 and 20, the container 1 includes the following components: the base panel 16A (which can be generally circular); two side panels 17A, which together form the generally circular wall; the top hem 17B on each side panel 17A; two side hems 17D on each side panel, at the opposite ends of each side panel; two handles 11 for fastening respectively to portions of the top hems 17B; and the co-operating fasteners 7A, 7B for fastening to the side hems 17D at the ends of each side panel 17A. Each of the co-operating fasteners 7A, 7B is attached by multiple stitches—including at least double stitches, triple stitches or quadruple stitches—along its length to the corresponding side hem 17D. The side hem 17D can be about 25 mm in width. The side panels 17A are fastened to the base panel by multiple stitches—including at least double stitches, triple stitches or quadruple stitches—around the base panel 16A.

In embodiments, as shown in FIG. 20, each of the handles 11 can be fastened to the top of the corresponding side with a plurality of stitches at a plurality of angles, including at least two parallel stitches and at least two perpendicular stitches at an angle (e.g., 45 degrees) to the parallel stitches, e.g., a square stitch containing a cross stitch 210 (e.g., the square stitch can be about 20 mm on each side, and the cross stitch can fit between the vertices of the square).

In embodiments, as shown in FIG. 20, the container 1 can include a tag 220 formed of fabric fastened to the top end of the closures 2 to be accessed and used manually by a person opening or closing the closures 2. Each tag 220 can be attached to the outer of the container 1 by being attached to the outer one of the co-operating fasteners 7A, 7B. Each tag 220 may be formed of plain UV-resistant fabric to facilitate opening of the closures 2. Each tag 220 may include additional fastening material corresponding to that in the closure 2, e.g., hook-and-loop tape, on the interior face (i.e., the face of the tag 220 facing inwards into the container 1) to enable the tag 220 to be fastened down into the container 1 so that the tag 220 does not project above the container 1 when it has been fastened down: such a tag 220 may be referred to as a “fastening tag”. The fastening tag can strengthen the top of each closure 2 when in the closed condition to reduce accidental opening of the closure 2, e.g., during movement of the container 1 with a plant therein, or during long periods of storage and growth. Keeping the closure 2 closed may mitigate UV or weather damage to the connecting parts of the closure 2 (e.g., the hooks and the loops), which may be more sensitive than the exterior of the closure 2. In embodiments, the tag 220 may be formed of an end portion of the closure 2 that extends above the sides of the container 1, and can be folded over to act as the fastening tag. The fastening tag may be formed by sewing one of the co-operating fasteners 7A, 7B over the top of its attached side panel 17A and down the other side by a suitable distance, e.g., the height of the top hem 17B (e.g., about 25 mm) and leaving the end of the other of the co-operating fasteners 7A, 7B to be openable and act as the fastening tag. The fastening tag can be either of the co-operating fastener 7A, 7B, and can extend over the side of the container either inwards (to fasten its loose end inside the container) or outwards (to fasten its loose end outside of the container, in which case the face of the tag 220 would be facing outwards from the container 1).

In embodiments, as shown in FIG. 21, the container 1 in a condition of use can include a plant 230 and soil 240 in which the plant can grow.

A technical construction method of the container 1 includes steps of:
cutting panels (also referred to as “pieces” or “sections”) from the mesh in selected shapes and sizes for a pre-selected container volume or size;
hemming the panels;
attaching the co-operating fasteners 7A, 7B by sewing (also referred to as “stitching”) them in place;
heat sealing the handle 11 on its edges to prevent fraying;
attaching the handle 11 by aligning the handle 11 along the side, directly adjacent the side, and at a top of the side, so that the handle aligns with the top of the side when not pulled away from the side, and sewing the handle 11 to each of the side walls in a central position;
attaching the hemmed base panel to the hemmed size panels by sewing to construct (or assemble or form) the container 1; and
removing loose threads.

The co-operating fasteners 7A,7B are sewn onto the side panels: one side panel can have a strip of one type of fastener 7A at each end, and the other side panel can have a strip of the other type of fastener 7B at each end.

A method of growing a plant in the container 1 includes steps of: growing the plant in the plant container 1; and air-pruning roots of the plant that reach the mesh in the sides and/or the base of the container 1.

In use, the roots can extend to the edge of or out of the growing media, reaching the mesh and sometimes reaching through the mesh, during their growing phase. Subsequently, exposure to air (and light) prunes these roots back, and the exposed root portions die off due to the air-pruning process.

### Applications

A commercial nursery may have multiple applications for the container 1 in respect of: new seedlings; potting on from a smaller container size to an advanced size; grafted trees; bare root trees; plants; and shrubs. The commercial nursery industry encapsulates are large variety of plants and trees that are planted into a variety of containers. Some are destined for retail nurseries and others for commercial clients, in particular commercial clients for planting projects.

### Alternatives

The container sides and base can be formed of the same mesh material, or a combination of different mesh materials that provide sufficient strength and air-pruning. The container sides and base can be formed entirely of the mesh (including a plurality of different meshes), or at least substantially of the mesh so that sufficient air-pruning occurs around the sides and the base: for example, a fraction of the sides and/or the base may be formed of a non-mesh material, e.g., a fabric or other material, without substantively hindering the air-pruning functions of the container.

The mesh fabric 10, the closure materials, the stitching and the handle may be formed of other selected materials having an equivalent grade and strength to endure variances in respect to heat and cold, UV, media and fertilisers, and exposure to prolonged episodes of moisture over up to one or more years.

The mesh may include metal strands. The mesh may include wire webbing. The plastic mesh may include extruded plastic mesh with integral joints between transverse strands. The plastic mesh may include expanded plastic mesh formed by cutting holes in a continuous plastic sheet and expanding the cut sheet to form the plastic mesh. The mesh may include vinyl and/or rubber strands.

The hole sizes (also referred to as “aperture sizes”), mesh fabric weight, and mesh fabric thickness are selected such that:
the container has sufficient strength to hold the plant and the relevant media;
the mesh has sufficient air porosity to provide air pruning;
the mesh has sufficient porosity to be cleaned by water for re-use with a new plant after an old plant has been removed, including cleaning off undesirable growing media, and/or fungal spores;
the base material has sufficient water porosity for water drainage; and
the container has sufficient resistance to the media, the water and UV light to hold the plant during its growth phase, and can be re-used as required.

The relevant media may be selected based on standards relating to types of the plants, e.g., Australian standards for growing trees, including Australian standard AS3743-2003.

The co-operating fasteners 7A,7B can be relatively quick and easy to open and close, e.g., similar to hook-and-loop closures, and can be formed from materials that withstand exposure to media, water and UV light as required, including:
magnetic closures sewn into the walls of the container 1;
metal or plastic zips;
metal or plastic hook-and-eye joiners;
metal or plastic buttons with cooperating button holes;
plastic clip locks, e.g., formed from nylon; and/or
press studs.

The shape of the container 1 viewed from above is generally defined by the shape of the base, and the continuous wall formed by the sides in the closed condition has a corresponding shape when viewed from above. As described above, the base can be circular, with a circular base panel. Alternatively, the base can form other shapes, including two-dimensional closed polygon shapes, including squares and rectangles, with corresponding base panel shapes.

### Example Embodiments

In embodiments, the base and sides can be formed of a fabric with the following properties: 50% shade cloth fabric; black colour; HDPE knitted filament; UV stabilised (10 year); 196 gsm weight; 51-56% open area; break force (WARP) of 741 N/50 mm; break force (WEFT) of 530 N/50 mm; burst force of 2100 kPa; ball burst of 1353 N; elongation (WARP) of 51.5%; elongation (WEFT) of 64.8%; tear strength (WARP) of 115 N; and tear strength (WEFT) of 103 N. The handle can be formed of a material with the following properties: 25 mm webbing tape; black colour; polypropylene (PP) woven; heavy duty; UV stabilised; and break strength of 2000 N. The cooperating fasteners can include hook-and-loop tape with the following properties: 25 mm hook and look tape; black colour; heavy duty; and UV stabilised. The stitching can be formed using a polyester filament, e.g, 100% polyester, chemically coated and UV stabilised with high abrasion resistance and a black colour, e.g,. T40 HT Ultimo poly filament.

In embodiments, the components of the container 1 can have the following dimensions: 415 mm diameter base panel; 614 mm wide and 345 mm high side panels; 300 mm long (i.e., high) closures; and220 mm long fabric strips for the handles 11. For different sizes of the container 1, in litres (L), the diameter of the base panel and the height of the side panels can be the following respectively: for 8 L, 230 mm diameter and 200 mm height; for 18 L, 310 mm diameter and 250 mm height; for 30 L, 375 mm diameter and 275 mm height; for 45 L, 440 mm diameter and 300 mm height; for 75 L, 545 mm diameter and 325 mm height; and for 100 L, 600 mm diameter and 350 mm height.

### Interpretation

Many modifications will be apparent to those skilled in the art without departing from the scope of the present invention.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

1. A plant container with one or more sides including a mesh for air pruning.

2. The container of claim 1, wherein the mesh includes plastic strands.

3. The container of claim 1, wherein the mesh includes a mesh fabric with a knitted mesh and/or a woven mesh.

4. The container of claim 3, wherein the mesh fabric is a shade cloth.

5. The container of claim 1, wherein the mesh includes holes that form two-dimensional shapes.

6. The container of claim 5, wherein the holes have widths between 10 millimetres (mm) and 1 mm, or between 6 mm and 3 mm.

7. The container of claim 1, wherein the mesh includes a ultra-violet (UV) light-resistant material.

8. The container of claim 7, wherein the mesh has a UV resistance between 30% and 90%.

9. The container of claim 1, including a base including the mesh.

10. The container of claim 1, including one or more handles on the sides.

11. The container of claim 10, wherein the handles are adjacent a top of the container.

12. The container of claim 10, wherein the handles are fabric handles.

13. The container of claim 10, wherein the handles are configured to rest directly against the sides in a closed condition, and wherein the handles and the sides are configured to be pulled manually mutually apart into an open condition.

14. The container of claim 1, wherein the sides include at least one closure extending from a top of the container.

15. The container of claim 14, wherein the at least one closure includes a plurality of closures, including two closures in opposite sides of the container.

16. The container of claim 14, wherein at least one closure extends from the top to a base of the container.

17. The container of claim 14, wherein the closure includes cooperating fasteners on its adjacent side panels forming the sides.

18. The container of claim 17, wherein the fasteners include cooperating strips of hook and loop fasteners.

19. The container of claim 1, wherein the one or more sides form a continuous wall around the container.

20. The container of claim 1, wherein the one or more sides, and a base, form a bag substantially formed of the mesh.

21. A method of manufacturing a plant container, including a step of forming sides or a base of the plant container using a mesh for air pruning.

22. The method of claim 21, including a step of forming the sides and the base of the container using the mesh.

23. The method of claim 22, including steps of hemming the base, and sewing the sides to the base using stitches.

24. The method of claim 21, including a step of attaching one or more handles to the sides.

25. The method of claim 23, wherein the step of attaching the handles includes aligning a fabric strip forming the handle along the side, directly adjacent the side, and at a top of the side, so that the handle aligns with the top of the side when not pulled away from the side.

26. The method of claim 21, including a step of forming at least one closure in the one or more sides.

27. The method of claim 26, wherein the step of forming the closure includes terminating adjacent side panels forming the sides with cooperating fasteners.

28. The method of claim 27, wherein the fasteners including cooperating strips of hook and loop material.

29. The method of claim 21, including hemming the edges of the sides.

30. A kit including:
the plant container of claim 1; and
a stand configured to hold the plant container off the ground, and to allow air circulation for air pruning underneath the base of the plant container.

31. The kit of claim 27, wherein the stand includes bars or a grid for supporting the plant container, and legs to support the bars or the grid away from the ground.

32. The container of claim 1, including: a plant with roots extending to the mesh, wherein the roots are pruned by exposure to air and/or light at the mesh.

33. A method including steps of:
growing a plant in a plant container; and
air pruning roots of the plant that reach a mesh in sides and/or base of the container.
